(19) United States
(12) Patent Application Publication
(10) Pub. No.: US 2009/0201206 A1
(43) Pub. Date: Aug. 13, 2009

(54) METHOD AND SYSTEM FOR FLEXIBLE BEAMPATTERN DESIGN USING WAVEFORM DIVERSITY

(75) Inventors: Jian Li, Gainesville, FL (US); Petre Stoica, Uppsala (SE); Yao Xie, Gainesville, FL (US)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: UNIVERSITY OF FLORIDA RESEARCH FOUNDATION, INC., Gainesville, FL (US)

(21) Appl. No.: 12/298,448

(22) PCT Filed: Apr. 27, 2007
(86) PCT No.: PCT/US07/67648

§ 371 Date: Oct. 24, 2008

Related U.S. Application Data
(60) Provisional application No. 60/745,810, filed on Apr. 27, 2006.

(51) Int. Cl. H01Q 3/00

(52) U.S. Cl. 342/373

(57) ABSTRACT

A system and method of designing a transmit beam pattern for Waveform Diversity is provided. The method can include minimizing a difference between the transmit beampattern and a desired beampattern under an elemental constraint, and minimizing the cross-correlations between the plurality of probing signals at the one or more target locations. Desirable features of a probing signal can be achieved by designing a covariance matrix of the probing signal. The method also can include minimizing the peak sidelobe level while pointing an energy beam in a prescribed direction under an elemental power constraint.

### FIELD OF THE INVENTION

The present invention relates to the field of signal processing, and more particularly, to processing signals corresponding to beampattern designs for use in radar, sonar, acoustics, and other systems using multiple transmit sensors.

### BACKGROUND

Transmit beampattern design is important in many diverse applications, ranging from commercial and military communications systems, to weapons and surveillance systems for national defense and homeland security, to numerous types of biomedical applications for diagnosis and treatment. A particular example of a system in which transmit beampattern design can be critical is a high-power microwave (HPM) directed-energy weapon (DEW) system designed to destroy a target by focusing on the target microwave energy. Another example, is a system for delivering sufficient ultrasound energy to destroy a tumor in a patient.

These and various other types of systems using multiple sensors can be significantly enhanced by exploiting waveform diversity. Waveform diversity provides a new paradigm for flexible beampattern design. Waveform diversity refers to the use of various signal waveforms to enhance system performance relating to various tasks, such as detection and/or identification of targets when confronting interference and noise. Waveform diversity can be exploited spatially using multiple sensors. Waveform diversity also can be exploited in the time-frequency domain using distinct waveforms of different durations over different spectral bands. Other aspects, such as polarization and energy distribution of transmit signals also can be exploited for the sake of further waveform diversity.

As already noted, transmit beampattern design is important in many diverse applications, ranging from national defense and homeland security to numerous types of biomedical applications for diagnosis and treatment. Not surprisingly, therefore, the paradigm for flexible beampattern design can be applied to many different systems using multiple transmit sensors.

Notwithstanding the benefit of waveform diversity exploitation, there remains a need for a more effective and efficient mechanism for determining a desirable transmit beampattern. Likewise, there remains a need for an effective and efficient mechanism for obtaining the desired transmit beampattern for different applications.

### SUMMARY

The present invention relates generally to a system and method for designing a transmit beampattern using waveform diversity. The invention, more particularly, provides mechanisms for determining desired transmit beampatterns. The invention also provides mechanisms for obtaining desired transmit beampatterns. One aspect of the invention is the use of cross-correlation between signals reflected back to a system's sensors from a target of interest; the inclusion of the cross-correlation can be used to modify, in several different respects, the conventional criterion of beampattern matching. Another aspect of the invention is the presentation of a minimum sidelobe beampattern design. Still another aspect of the invention is an efficient algorithmic-based semi-definite quadratic programming (SQP) procedure. The SQP procedure can solve the signal design problem in polynomial time.

### BRIEF DESCRIPTION OF THE DRAWINGS

There are shown in the drawings, embodiments which are presently preferred. It is expressly noted, however, that the invention is not limited to the precise arrangements and instrumentalities shown.

FIG. 1 is a schematic diagram of a waveform diversity system in accordance with one embodiment of the invention;

FIG. 2 is a schematic diagram of signal processing components of the waveform diversity system of FIG. 1;

FIGS. 3(a) and 3(b) are plots of the Capon spatial spectrum and the GLRT pseudo-spectrum as functions of θ, respectively, in accordance with the invention;

FIGS. 4(a)-4(c) are plots of beampattern matching designs, in accordance with the invention;

FIGS. 5(a) and 5(b) are plots of MIMO beam pattern matching designs, in accordance with the invention;

FIGS. 6(a) and 6(b) are plots of the beam pattern differences and corresponding MSE, respectively, resulting from using \hat{R}ₓₓ in lieu of R.

FIGS. 7(a) and 7(b) are plots of MSEs of location estimates and of complex amplitude estimates under the uniform elemental power constraint, in accordance with the invention;

FIGS. 8(a)-8(d) are plots of Capon and GLRT using omni-directional and optimal beam pattern matching designs, in accordance with the invention;

FIGS. 9(a) and 9(b) are plots of minimum sidelobe beam pattern designs, under the uniform elemental power constraint, when the 3 dB main-beam width is 20°, in accordance with the invention; and

FIGS. 10(a) and 10(b) are plots of minimum sidelobe beam pattern designs, under a relaxed (±20%) elemental power constraint, when the 3 dB main-beam width is 20°, in accordance with the invention.

### DETAILED DESCRIPTION

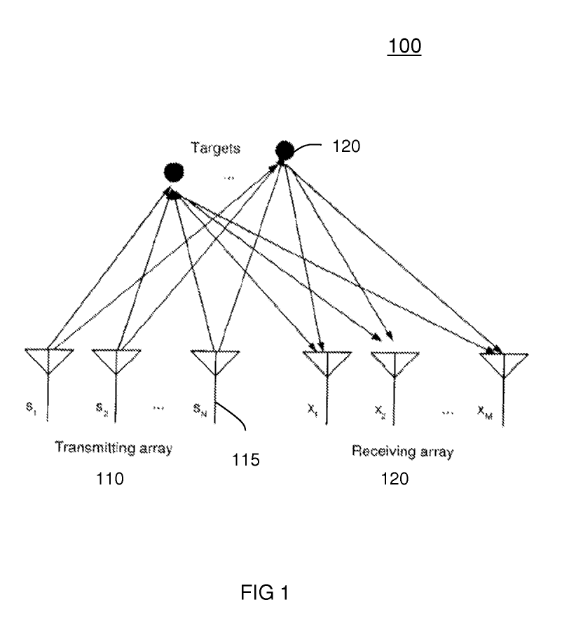

Referring initially to FIG. 1, a Waveform Design (WD) system 100 according to one embodiment of the invention is shown. Generally, the WD system 100, unlike a standard phased-array system, can freely choose the probing signals transmitted via its antennas to maximize the power at locations in proximity to the locations of targets of interest, or more generally, to approximate a given transmit beam pattern. The WD system 100 also can minimize the cross-correlation of the signals reflected back to the system by the targets of interest. The WD system 100 can be used to identify one or more targets 120 within range.

The WD system 100 illustratively includes a transmitting array 110 and a receiving array 120. Multiple probing pulses can be transmitted from multiple transmitting sensors 115 towards a target 120. A power of the probing signal energy can be evaluated at the target. The probing signal can be reflected off the target 120 and sent back in a direction of the WD system 100. Receiving antennae in the receiving array 120 can capture the reflected signals. Various signal processing techniques can be applied to the signals transmitted and received by the WD system for identifying the range and angle of the target.

Waveform diversity offers a new paradigm for flexible beampattern design. For an M-sensor array, under the elemental power constraint (i.e., the transmit power constraint for each sensor element), the number of degrees of freedom (DOF) that can be used for beampattern design according to the conventional approach is equal to only M−1 real-valued parameters; consequently, it is difficult for the conventional approach to synthesize a proper beam. The waveform diversity approach according to the invention, however, can be used to achieve an improved beampattern due to its much larger number of DOF.

Understandably, the WD system 100 can deliver substantial amounts of power on a target for a specified period of time. As an example, the WD system 100 can be used in a HPM DEW to direct a focused beam of energy for inflicting damage on a target. The greater the energy density (fluence) on a target, the greater the assurance that damage has been inflicted. Often, the exact location of the target is not known, as in the case of a target that is camouflaged or located somewhere inside a building. In some cases the target is moving rapidly, as would be the case, for example, when the target is a shoulder launched guided missile. Since the determination of the exact location of a hostile target, as the tracking of a rapidly moving target, is a time consuming operation, it is desirable that the DEW possess a sufficiently broad main beam so that the target is radiated for the amount of time necessary to assure that damage is inflected, while simultaneously insuring little or no collateral damage. Concern over collateral damage is of particular importance in applications such as airport defense where the concentration of friendly targets which can also be harmed is high.

As another example, the WD system 100 can be applied in hyperthermia and thermal surgery systems, such as for treating breast cancer. The aim of both hyperthermia and thermal surgery is to use heat to damage and kill breast cancer cells. The goal of hyperthermia is to expose tumor to a high temperature (up to 45° C.) for up to 60 minutes while causing minimal injury to normal tissue. Hyperthermia can shrink tumors and make chemotherapy and/or radiation therapy more effective. Thermal therapy exposes the tumor to a much higher temperature (50° C.-90° C.) for several seconds to minutes without harming the healthy tissue. Thermal therapy can be used as a stand-alone surgery.

In practice, ultrasound arrays have typically been considered for breast cancer hyperthermia and thermal surgery. However, the maximum power that can be generated by each element of the ultrasound array is limited to avoid burning the healthy tissue such as the skin. As a result, a large aperture array is needed to deliver sufficient ultrasound energy to the tumor while avoiding damaging healthy tissue. Due to the short waveform length of the ultrasound sound and the large aperture array, the main beam width achieved by the conventional transmit beampattern design approach is too small. The current practice is to heat one spot of a tumor at a time, prolonging the time needed for treatment as well as causing the concern that some cancer cells may be missed. The transmit beampattern design problem encountered in the ultrasound-based cancer hyperthermia and thermal surgery application is thus very similar to that of the directed energy weapon systems and flexible transmit beampattern design schemes. Accordingly, the WD system 100 is well suited for delivering concentrated energy at a particular location of the tissue.

As another example, the WD system 100 can be applied for use in applications concerning active sonar. One application of the WD system 100 is suppressing sounds in the ocean. It is known that active sonar systems used by the military to locate submarines as well as the seismic survey systems for off-shore oil and gas exploration are two of the major forms of noise pollution in the ocean. The noise pollution caused by these systems, as alleged by environmental groups, can hurt and even kill ocean creatures like whales. Flexible transmit beampattern designs can help reduce such noise pollution. For an active sonar system, for example, instead of using a single active sonar platform to probe the ocean, a distributed active sonar network is a viable alternative. Like the previous ultrasound array example, the maximum power that each active sonar platform in the network can generate is limited to ensure the safety of the whales and other ocean creatures. Flexible transmit beampattern designs can be used to achieve a desired power at a focal point with a sufficient beam width while minimizing the power at all other areas. Accordingly, the WD system 100 is well suited for delivering concentrated energy at predetermined locations in the ocean. Aspects of the WD system are also applicable to making the seismic survey systems quieter as well.

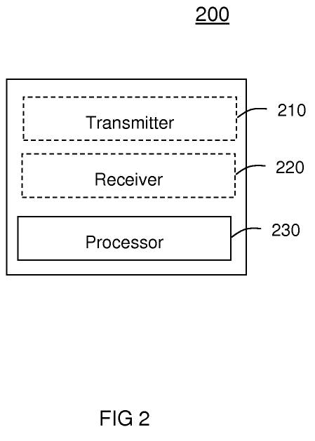

Referring to FIG. 2, signal processing components of the WD system 100, according to one embodiment, are shown. The signal processing components 200 of the WD system 100 illustratively include a transmitter 210, which communicatively couples to the transmitting array 110 of the system for transmitting one or more probing signals, and a receiver 220, which communicatively couples to the receiving array 110 of the system for receiving a reflection of the one or more probing signals. Each transmitting antennae 115 can submit a probing signal simultaneously and the power distribution defines a transmit beam pattern.

In an exemplary WD system with M transmit antennas, xₘ(n) can denote the discrete-time baseband signal transmitted by the m th antenna. Additionally, θ can denote the location parameter(s) of a generic target, for example, its azimuth angle and its range. Under the assumption that the transmitted probing signals are narrowband and that the propagation is non-dispersive, the baseband signal at the target location can be described by EQ. (1):

$${\sum }_{m = 1}^{M} {e}^{- j 2 π {f}_{0} {τ}_{m} ( θ )} {x}_{m} ( n ) = {a}^{*} ( θ ) x ( n ) , n = 1 , … , N , \qquad ( 1 )$$

where f₀ is the carrier frequency of the radar, τₘ(θ) is the time needed by the signal emitted via the m th transmit antenna to arrive at the target, (•)* denotes the conjugate transpose, N denotes the number of samples of each transmitted signal pulse,

x(n)=[x₁(n)x₂(n) . . . x_{M}(n)]^{T}, (2)

and

a(θ)=[e^{j2πf}^{₀}^{τ}^{₁}^{(θ)}e^{j2πf}^{₀}^{τ}^{₂}^{(θ)}. . . e^{j2πf}^{₀}^{τ}^{_{M}}^{(θ)}]^{T}, (3)

with (•)^{T} denoting the transpose. Assuming that the transmit array of the radar is calibrated, a(θ) is a known function of θ. It follows from EQ. (1) that the power of the probing signal at a generic focal point with location θ is given by EQ. (6):

P(θ)=a*(θ)Ra(θ), (4)

where R is the covariance matrix of x(n), i.e.,

R=E{x(n)x*(n)}. (5)

The “spatial spectrum” in EQ. (4), as a function of θ, refers to the transmit beam pattern. R is a design parameter that can be chosen under a uniform elemental power constraint,

$${R}_{mm} = \frac{c}{M} , m = 1 , … , M ; with c given , \qquad ( 6 )$$

where Rₘₘ denotes the (m, m) th element of R and is chosen to maximize the total spatial power at a number of given target locations, or more generally, match a desired transmit beam pattern, and minimize the cross-correlation between the probing signals at a number of given target locations; note from (1) that the cross-correlation between the probing signals at locations θ and θ̅ is given by a*(θ)Ra( θ̅).

R can be chosen such that the available transmit power is used to maximize the probing signal power at the locations of the targets of interest and to minimize it anywhere else. Also, the statistical performance of an adaptive WD technique depends on the cross-correlation (beam) pattern a*(θ)Ra( θ̅) (for θ≠ θ̅), wherein the performance degrades rapidly as the cross-correlation increases. Such data, under the simplifying assumption of point targets, can be described by EQ. (7):

$$y ( n ) = {\sum }_{k = 1}^{K} {β}_{k} {a}^{c} ( {θ}_{k} ) {a}^{*} ( {θ}_{k} ) x ( n ) + ɛ ( n ) , \qquad ( 7 )$$

where K is the number of targets that reflect the signals back to the radar receiver, {βₖ} are the complex amplitudes proportional to the radar-cross-sections (RCS's) of those targets, {θₖ} are their location parameters, ε(n) denotes the interference-plus-noise term, and (•)^{c} denotes the complex conjugate. R can be chosen under the uniform elemental power constraint of EQ. (6) to minimize the sidelobe level in a prescribed region, and achieve a predetermined 3 dB main-beam width.

Once R has been determined, a signal sequence {x(n)} that has R as its covariance matrix can be synthesized in a number of ways. Herein x(n) can be set to as x(n)=R^{1/2}w(n), where {w(n)} is a sequence of independent, identically distributed (i.i.d.) random vectors with mean zero and covariance matrix I, and R^{1/2} denotes a square root of R. However, such a synthesizing procedure may not give a signal that satisfies all practical requirements of a real-world radar system; that is, the above signal does not have a constant modulus.

A maximum power design for unknown target locations is presented. Assume that there are \tilde{K} (\tilde{K}≦K) targets of interest. Without loss of generality, the targets can be assumed to be at locations {θₖ}ₖ₌₁^{\tilde{K}}. Then the cumulated power of the probing signals at the target locations is given by EQ. (8):

$$\begin{matrix}{\sum }_{k = 1}^{\tilde{K}} {a}^{*} ( {θ}_{k} ) Ra ( {θ}_{k} ) = tr ( RB ) , \\ where & ( 8 ) \\ B = {\sum }_{k = 1}^{\tilde{K}} a ( {θ}_{k} ) {a}^{*} ( {θ}_{k} ) . & ( 9 )\end{matrix}$$

It can be assumed that the radar has no prior knowledge on B. As a consequence, R can be chosen such that it maximizes EQ. (8) in the worst-case scenario:

$${max}_{R} {min}_{B} tr ( RB ) subject to {R}_{mm} = \frac{c}{M} , m = 1 , … , M \\ R \geq 0 \\ B \geq 0 ; B \neq 0 , \qquad ( 10 )$$

where the notation R≧0 means that R is a positive semi-definite matrix, and the constraint B≠0 is required to eliminate the trivial “solution” B=0 to the inner minimization.

The solution to the maximum design problem is similar to EQ. (10), but, with the uniform elemental power constraint Rₘₘ=c/M, m=1, . . . , M, replaced by a less stringent total power constraint tr (R)=c, is

$$R = \frac{c}{M} I . \qquad ( 11 )$$

Given that EQ. (11) also satisfies the uniform elemental power constraint, this is the solution to the maximum design problem in EQ. (10) as well. Consequently, without prior information as to where the targets of interest are located, the WD will transmit a spatially white probing signal, which gives a constant power at any location θ, namely (c/M)∥a(θ)∥²=c (note that ∥a(θ)∥²=M, where ∥•∥ denotes the Euclidean norm).

Information about the approximate locations of the targets of interest is assumed to be available. (The mechanism by which this information can be obtained is described below.) Assume that an estimate \hat{B} of B is available. Accordingly, the inner minimization in EQ. (10) can be omitted, and the design problem becomes one of maximizing the total power at the locations of the targets of interest, under the uniform elemental power constraint. While this problem is a Semi-Definite Program (SDP) and can, therefore, be efficiently solved numerically, it does not appear to admit a closed-form solution, unlike EQ. (10). For this reason, in the following, a total power constraint is considered instead of the elemental power one, namely:

$${max}_{R} tr ( R \hat{B} ) subject to tr ( R ) = c \\ R \geq 0. \qquad ( 12 )$$

By a well-known inequality in matrix theory:

tr(R\hat{B})≦λₘₐₓ(\hat{B})tr(R)=cλₘₐₓ(\hat{B}), (13)

where λₘₐₓ(\hat{B}) denotes the largest eigenvalue of \hat{B}, and where the last equality follows from the constraint tr(R)=c. The upper bound in EQ. (13) is evidently achieved for

R=cuu*, (14)

where u is the (unit-norm) eigenvector of \hat{B} associated with λₘₐₓ(B).
Note that for \tilde{K}=1, EQ. (14) reduces to:

$$R = c \frac{a ( \hat{θ} ) {a}^{*} ( \hat{θ} )}{{‖ a ( \hat{θ} ) ‖}^{2}} , \qquad ( 15 )$$

the use of which leads to the delay-and-sum transmit beamformer employed in phased-array radar systems.

The maximum power design in EQ. (14) is computationally inexpensive, and in particular, the covariance matrix in EQ. (14) can be synthesized using a constant-modulus scalar signal pre-multiplied by u. However, the elemental transmit powers corresponding to (14) can vary widely. While the design of EQ. (14) maximizes the total power at the locations of the targets of interest, the way this power is distributed per each individual target is not controlled; consequently, the resulting powers at the target locations can be rather different from one another and from some possible desired relative levels. Moreover, the design of EQ. (14) does not control the cross-correlation (beam)pattern. The result is that for EQ. (14), and for any rank-one design, the normalized magnitude of the pattern is given by (for θ≠ θ̅):

$$\frac{\vert {a}^{*} ( θ ) Ra ( \overline{θ} ) \vert}{{{[ {a}^{*} ( θ ) Ra ( θ ) ]}^{1 / 2} [ {a}^{*} ( \overline{θ} ) Ra ( \overline{θ} ) ]}^{1 / 2}} = \frac{\vert {a}^{*} ( θ ) u \vert \vert {u}^{*} a ( \overline{θ} ) \vert}{\vert {a}^{*} ( θ ) u \vert \vert {a}^{⋆} ( \overline{θ} ) u \vert} = 1. \qquad ( 16 )$$

The signals backscattered to the radar by any two targets are therefore fully coherent, which in particular makes the adaptive localization techniques inapplicable.

Maximizing the signal-to-interference-plus-noise ratio (SINR) at the receiver leads to a problem that has precisely the form in (10) or (12), but with a different matrix B. This is apparent by noting that maximizing the receiver's SINR with respect to R is equivalent to maximizing the following criterion:

$$tr [ {\sum }_{k = 1}^{K} {\sum }_{p = 1}^{K} {β}_{k} {β}_{p}^{*} {a}_{k}^{c} {a}_{k}^{*} {Ra}_{p} {a}_{p}^{T} ] = tr [ R \tilde{B} ] , \qquad ( 17 )$$

where aₖ is a short notation for a(θₖ), and

$$\tilde{B} = {\sum }_{k = 1}^{K} {\sum }_{p = 1}^{K} ( {β}_{k} {β}_{p}^{*} ) ( {a}_{p}^{T} {a}_{k}^{c} ) ( {a}_{p} {a}_{k}^{*} ) , \qquad ( 18 )$$

(it can be readily determined that \tilde{B}≧0). Clearly, the cost functions in (10), (12), and (18) have the same form. Furthermore, for well-separated targets (for which aₚ^{T}aₖ^{c}≈0 for p≠k) with similar βₖ's, \tilde{B}≈B (to within a multiplicative constant).

Maximizing the SINR of the received data may be a more justifiable goal than maximizing the signal's power at the target locations. Nevertheless, the foregoing focus is on EQ. (12), because EQ. (12) is closer than EQ. (17) to the general framework of transmit beam pattern matching design of the next subsection. Accordingly, the design derived from EQ. (12), as well as the one introduced in the following paragraphs, rely only on a model for the transmit beam pattern, whereas EQ. (17) and the corresponding design would also require the use of a model for the received data.

The maximum power criterion is replaced with a beam pattern matching criteria that accommodates the uniform elemental transmit power constraint and allows an approximate control of the power at each target location. In particular, the new criterion also includes a term that penalizes large values of the cross-correlation (beam) pattern.

Herein, φ(θ) denotes a desired transmit beam pattern, and {μₗ}ₗ₌₁^{L} can be a fine grid of points that cover the location sectors of interest. It can be assumed that the grid contains points which are good approximations of the locations {θₖ}ₖ₌₁^{\tilde{K}} of the targets of interest. Moreover, as already described in the previous paragraphs, (initial) estimates {\hat{θ}ₖ}ₖ₌₁^{\tilde{K}} of {θₖ}ₖ₌₁^{\tilde{K}} can be disposed of.

One goal is to choose R such that the transmit beam pattern, a*(θ)Ra(θ), matches, or rather approximates (in a least squares (LS) sense), the desired transmit beam pattern, φ(θ), over the sectors of interest, and also that the cross-correlation (beam)pattern, a*(θ)Ra( θ̅) (for θ≠ θ̅), is minimized (for example, in an LS sense) over the set {\hat{θ}ₖ}ₖ₌₁^{\tilde{K}}. Mathematically, therefore, the following problem is to be solved:

$${min}_{α , R} \{ \begin{matrix}\frac{1}{L} {\sum }_{l = 1}^{L} {{w}_{l} [ αφ ( {μ}_{l} ) - {a}^{*} ( {μ}_{l} ) Ra ( {μ}_{l} ) ]}^{2} + \\ \frac{2 {w}_{c}}{{\tilde{K}}^{2} - \tilde{K}} {\sum }_{k = 1}^{\tilde{K} - 1} {\sum }_{p = k + 1}^{\tilde{K}} {\vert {a}^{*} ( {\hat{θ}}_{k} ) Ra ( {\hat{θ}}_{p} ) \vert}^{2}\end{matrix} \} \\ subject to {R}_{mm} = \frac{c}{M} , m = 1 , … , M \\ R \geq 0 , \qquad ( 19 )$$

where w₁≧0, l=1, . . . L, is the weight for the lth grid point and w_{c}≧0 is the weight for the cross-correlation term. The value of wₗ should be larger than that of wₖ if the beam pattern matching at μₗ is considered to be more important than the matching at μₖ. Note that by choosing maxₗ wₗ>w_{c} more weight can be given to the first term in the design criterion above, and vice versa for maxₗ wₗ<w_{c}.

The above criterion appears to improve the design of the transmit beam pattern. In particular, the beam pattern matching criterion includes a user term that penalizes large values of the cross-correlation beam pattern, the least squares error fitting is directly applied to the desirable transmit beam-pattern, and a scaling factor is applied to approximate a scaled version of the beam pattern. Additionally, the design problem of EQ. (19) can be efficiently solved in polynomial time as a SQP.

To show that EQ. (19) is a SQP, some additional notation is provided. Herein, vec(R) denotes the M²×1 vector obtained by stacking the columns of R on top of each other. Additionally, r denotes the M²×1 real-valued vector made from Rₘₘ (m=1, . . . , M) and the real and imaginary parts of Rₘₚ, (m, p=1, . . . , M; p>m). Then, given the Hermitian symmetry of R,

vec(R)=Jr (20)

for a suitable M²×M² matrix J whose elements are easily derived constants (0,±j,±1). Making use of EQ. (2) and certain properties of the vector operator, it can be verified that

$$\begin{matrix}\begin{matrix}{a}^{⋆} ( {μ}_{l} ) Ra ( {μ}_{l} ) = vec [ {a}^{*} ( {μ}_{l} ) R a ( {μ}_{l} ) ] \\ = [ {a}^{T} ( {μ}_{l} ) ⊗ {a}^{⋆} ( {u}_{l} ) ] J r \\ = - {g}_{l}^{T} r ,\end{matrix} & ( 21 ) \\ and & \\ \begin{matrix}{a}^{*} ( {\hat{θ}}_{k} ) Ra ( {\hat{θ}}_{p} ) = [ {a}^{T} ( {\hat{θ}}_{p} ) ⊗ {a}^{⋆} ( {\hat{θ}}_{k} ) ] J r \\ = {d}_{k , p}^{*} r ,\end{matrix} & ( 22 )\end{matrix}$$

where \hat{x} denotes the Kronecker product operator.

Inserting EQs. (21) and (22) into EQ. (19) yields the following more compact form of the design criterion (which shows clearly the quadratic dependence on r and α):

$$\begin{matrix}\frac{1}{L} {\sum }_{l = 1}^{L} {{w}_{l} [ α φ ( {μ}_{l} ) + {g}_{l}^{T} r ]}^{2} + \frac{2 {w}_{c}}{{\tilde{K}}^{2} - \tilde{K}} {\sum }_{k = 1}^{\tilde{K} - 1} {\sum }_{p = k + 1}^{\tilde{K}} {\vert {d}_{k , p}^{*} r \vert}^{2} = \frac{1}{L} {\sum }_{l = 1}^{L} {w}_{l} {\{ [ \begin{matrix}φ ( {μ}_{l} ) & {g}_{l}^{T}\end{matrix} ] [ \begin{matrix}α ( 5 ) \\ r\end{matrix} ] \}}^{2} + \frac{2 {w}_{c}}{{\tilde{K}}^{2} - \tilde{K}} {\sum }_{k = 1}^{\tilde{K} - 1} {\sum }_{p = k + 1}^{\tilde{K}} {\vert [ \begin{matrix}0 & {d}_{k , p}^{*}\end{matrix} ] [ \begin{matrix}α ( 6 ) \\ r\end{matrix} ] \vert}^{2} = {ρ}^{T} Γρ , & ( 23 ) \\ where & \\ ρ = [ \begin{matrix}α \\ r\end{matrix} ] , & ( 24 ) \\ and & \\ Γ = \frac{1}{L} {\sum }_{l = 1}^{L} {w}_{l} [ \begin{matrix}φ ( {μ}_{l} ) \\ {g}_{l}\end{matrix} ] [ \begin{matrix}φ ( {μ}_{l} ) & {g}_{l}^{T}\end{matrix} ] + Re \{ \frac{2 {w}_{c}}{{\tilde{K}}^{2} - \tilde{K}} {\sum }_{k = 1}^{\tilde{K} - 1} {\sum }_{p = k + 1}^{\tilde{K}} [ \begin{matrix}0 \\ {d}_{k , p}\end{matrix} ] [ \begin{matrix}0 & {d}_{k , p}^{*}\end{matrix} ] \} , & ( 25 )\end{matrix}$$

with Re(•) denoting the real part. The matrix Γ above is usually rank deficient. For example, in the case of an M-sensor uniform linear array with half-wavelength or smaller inter-element spacing and for w_{c}=0, one can show that the rank of Γ is 2M. The rank deficiency of Γ, however, does not pose any serious problem for the SQP solver outlined below.

Making use of the form in (23) of the design criterion, EQ. (19) can be rewritten as the following SQP:

$${min δ}_{δ , \tilde{n}} subject to ‖ \tilde{n} ‖ \leq δ \\ {R}_{mm} ( \tilde{n} ) = \frac{c}{M} , m = 1 , … , M \\ R ( \tilde{n} ) \geq 0 , \qquad ( 26 )$$

where (Γ^{1/2} denotes a square root of Γ)

ñ=Γ^{1/2}ρ, (27)

and the (linear) dependence of R on ñ is explicitly indicated. For practical values of an array of size M, the SQP above can be efficiently solved.

In some applications, it is desirable to have the synthesized beam pattern at some given locations be very close to the desired values. As previously mentioned, to a certain extent, this design goal can be achieved by the selection of the weights {w₁} of the design criterion in EQ. (19). However, in order to match the beam pattern with the desired values exactly, then selecting the weights {w₁} is insufficient, and a new design is introduced.

Consider, for instance, that the transmit beam pattern at a number of points is to be equal to certain desired levels. Then the optimization problem to solve is EQ. (19) with the following additional constraints:

a*(\check{μ}ₗ)Ra(\check{μ}ₗ)=ζ₁, l=1, . . . , \check{L}, (28)

where {ζ₁} are pre-determined levels. A similar modification of (19) takes place when the transmit beam pattern at a number of points {\check{μ}₁}ₗ₌₁^{\check{L}} is restricted to be less than or equal to certain desired levels. The extended problems (with additional either equality or inequality constraints) are also SQP's, and therefore, similarly to EQ. (19), they can be solved efficiently.

Briefly a review of how the desired transmit beam pattern, φ(θ), and the (initial) location estimates can be obtained is provided. Because at the beginning of the operation, the WD system is assumed to have no prior knowledge of the scene, a maximin power optimal signal can be transmitted towards the targets, for which R=(c/M)I. Using the data y(n)ₙ₌₁^{N} collected by the receiving array of the system, the generalized likelihood ratio test (GLRT) function can be computed, which is given by:

$$\begin{matrix}\tilde{φ} ( θ ) = 1 - \frac{{a}^{*} ( θ ) {\hat{R}}_{yy}^{- 1} a ( θ )}{{a}^{*} ( θ ) {\hat{Q}}^{- 1} a ( θ )} , & ( 29 ) \\ where & \\ \hat{Q} = {\hat{R}}_{yy} - \frac{{\hat{R}}_{yx} a ( θ ) {a}^{*} ( θ ) {\hat{R}}_{yx}^{*}}{{a}^{*} ( θ ) {\hat{R}}_{xx} a ( θ )} , & ( 30 ) \\ with & \\ {\hat{R}}_{yx} = \frac{1}{N} {\sum }_{n = 1}^{N} y ( n ) {x}^{*} ( n ) , & ( 31 )\end{matrix}$$

and \hat{R}ₓₓ and \hat{R}_{yy} similarly defined. (Note that, while R=(c/M)I, the sample matrix \hat{R}ₓₓ will in general be somewhat different from (c/M)I.) The above function \tilde{φ}(θ) possesses useful properties. For example, EQ. (29) has values close to one in the vicinity of the target locations {θₖ}ₖ₌₁^{K}, and close to zero elsewhere. And, EQ. (29) takes on small values even at the locations of possibly strong jammers, assuming that the jamming signals are uncorrelated with x(n). Also, the peaks of EQ. (29) around the target locations have widths that lead to a good compromise between resolution and robustness.

The locations of interest of the dominant peaks of \tilde{φ}(θ) can be used as estimates of {θₖ}ₖ₌₁^{\tilde{K}} and also to obtain a desired transmit beam pattern. Note that, in view of the features above, the exemplary WD system does not waste power by probing either jammer locations (which may have the added bonus of making the radar harder to detect) or locations of uninteresting targets (which allows the radar to transmit spatially more power towards the targets of interest).

In some applications, the beam pattern design goal is to minimize the sidelobe level in a certain sector, when pointing the WD toward θ₀. Such a minimum sidelobe beam pattern design problem, with the uniform elemental transmit power constraint, can be formulated as follows:

$${min}_{t , R} - t subject to {a}^{*} ( {θ}_{0} ) Ra ( {θ}_{0} ) - {a}^{*} ( {μ}_{l} ) Ra ( {μ}_{l} ) \geq t , ∀ {μ}_{l} ∈ Ω \\ {a}^{*} ( {θ}_{1} ) Ra ( {θ}_{1} ) = 0.5 {a}^{*} ( {θ}_{0} ) Ra ( {θ}_{0} ) \\ {a}^{*} ( {θ}_{2} ) Ra ( {θ}_{2} ) = 0.5 {a}^{*} ( {θ}_{0} ) Ra ( {θ}_{0} ) \\ R \geq 0 \\ {R}_{mm} = \frac{c}{M} , m = 1 , … , M , \qquad ( 32 )$$

where θ₂−θ₁ (with θ₂>θ₀ and θ₁<θ₀) determines the 3 dB main-beam width and Ω denotes the sidelobe region of interest. This is a SDP that can be solved in polynomial time. Similarly to the optimal SQP-based design of the previous subsection, if desired, the elemental power constraint can be replaced by a total power constraint. Note that the constraints in EQ. (32) can be relaxed by defining the 3 dB main-beam width; for instance, by replacing them by (0.5−δ)a*(θ₀)Ra(θ₀)≦a*(θᵢ)Ra(θᵢ)≦(0.5+δ)a*(θ₀)Ra(θ₀), i=1, 2, for some small δ. Such a relaxation leads to a design with lower sidelobes, and to an optimization problem that is feasible more often than EQ. (32).

Flexibility can be introduced in the elemental power constraint by allowing the elemental power to be within a certain range around c/M, while still maintaining the same total transmit power of c. Such a relaxation of the design problem allows lower sidelobe levels and smoother beam patterns, as shown by the exemplary numerical examples, below.

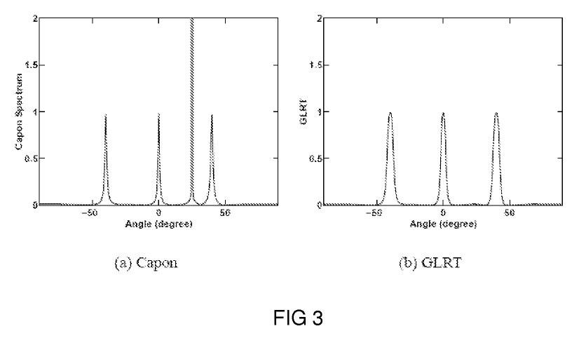

Referring to FIGS. 3-9, several numerical examples of the probing signal designs for WD systems are presented. For example, consider a WD with a uniform linear array (ULA) comprising M=10 antennas with half-wavelength spacing between adjacent antennas. The array is used both for transmitting and for receiving. Without loss of generality, the total transmit power is set to c=1.

Consider first a scenario where K=3 targets are located at θ₁=−40°, θ₂=0°, and θ₃=40° with complex amplitudes equal to β₁=β₂=β₃=1. There is a strong jammer at 25° with an unknown waveform (uncorrelated with the transmitted WD waveforms) with a power equal to 10⁶ (60 dB). Each transmitted signal pulse has N=256 samples. The received signal is corrupted by zero-mean circularly symmetric spatially and temporally white Gaussian noise with variance Γ². It can be assumed that only the targets reflect the transmitted signals. In practice, the background can also reflect the signals. In the latter case, transmitting most of the power towards the targets should generate much less clutter returns than when transmitting power omni-directionally. Therefore, a WD system with a proper transmit beam pattern design might provide even larger performance gains than those demonstrated herein.

Since no prior knowledge about the target locations is assumed, the initial probing relies on the maximum power beam pattern design for unknown target locations, i.e., R=(c/M)I. The corresponding transmit beam pattern is omni directional with power equal to c=1 at any θ. Using the data collected as a result of this initial probing, the target locations can be estimated using the GLRT technique, outlined in the previous section. Alternatively, location estimates can be obtained using the Capon technique, as the maximum points of the following spatial spectrum:

$$\frac{\vert {a}^{*} ( θ ) {\hat{R}}_{yy}^{- 1} {\hat{R}}_{yx} {a}^{c} ( θ ) \vert}{[ {a}^{*} ( θ ) {\hat{R}}_{yy}^{- 1} a ( θ ) ] [ {a}^{T} ( θ ) {\hat{R}}_{xx} {a}^{c} ( θ ) ]} . \qquad ( 36 )$$

FIGS. 3(a) and 3(b) show, respectively, the Capon spatial spectrum and the GLRT pseudo-spectrum as functions of θ, for the initial omni directional probing are shown. An example of the Capon spectrum for σ²=−10 dB is shown in FIG. 3(a), where very narrow peaks occur around the target locations. Note that in FIG. 3(a), a false peak occurs around θ=25° due to the presence of the very strong jammer. The corresponding GLRT pseudo-spectrum as a function of θ is shown in FIG. 3(b). Note that the GLRT is close to one at the target locations and close to zero at any other locations including the jammer location. Therefore, the GLRT can be used to reject the jammer peak in the Capon spectrum. The remaining peak locations in the Capon spectrum are the estimated target locations. Note that the Capon spectrum has sharper peaks than the GLRT function and hence, if desired, the Capon estimates of the target locations can be used in lieu of the GLRT estimates.

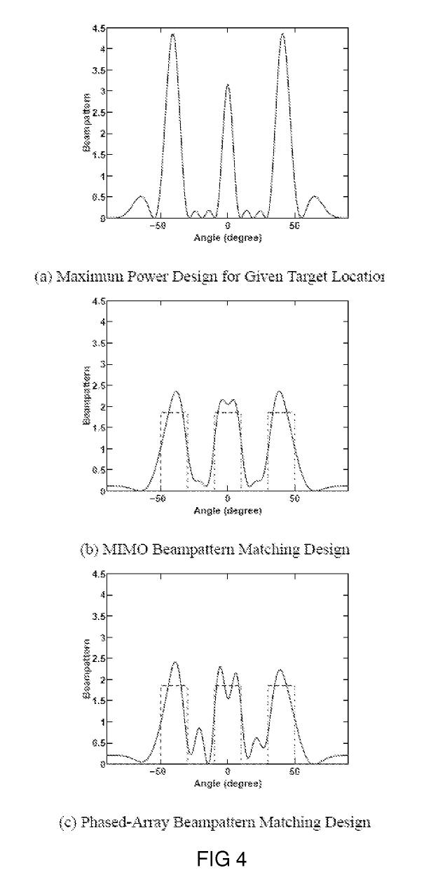

The initial target locations obtained by Capon or by GLRT can be used to compute the maximum power design; the GLRT estimates are used in the following. An example of the transmit beam pattern synthesized using the so-obtained R is shown in FIG. 4(a). Since the rank of R is equal to one for this design, the WD operates as a conventional phased-array radar in this case. As a consequence, in the presence of multiple targets, no data-adaptive approach can be used to obtain enhanced estimates of the target locations since the signals reflected by the targets are coherent with each other.

FIG. 4(a) shows the transmit beam patterns formed via maximum power design for given target locations (estimated via initial omni directional probing). FIG. 4(b) shows the MIMO beam pattern matching design with w_{c}=0 under the uniform elemental power constraint when Δ=10°. FIG. 4(c) shows the phased-array beam pattern matching design with w_{c}=0 under the uniform elemental power constraint when Δ=10°. The desired beam patterns (scaled by a) for the designs illustrated in FIGS. 4(b) and 4(c) are shown by dashed lines. The initial target location estimates obtained using Capon or the GLRT can also be used to derive a desired beam pattern for the beam pattern matching design. In the following numerical examples, the desired beam pattern can be formed by using the dominant peak locations of the GLRT pseudo-spectrum, denoted as \hat{θ}₁, . . . \hat{θ}_{\hat{K}}, as follows (with \hat{K} being the resulting estimate of K):

$$φ ( θ ) = \{ \begin{matrix}1 , & θ ∈ [ {\hat{θ}}_{k} - Δ , {\hat{θ}}_{k} + Δ ] , k = 1 , … , \hat{K} , \\ 0 , & otherwise ,\end{matrix} \qquad ( 37 )$$

where 2Δ is the chosen beam width for each target (Δ should be greater than the expected error in {\hat{θ}ₖ}).

The design shown in FIG. 4(b) is obtained using Δ=10° in the beam pattern matching design in EQ(19) with a mesh grid size of 0.1°, wₗ=1, l=1, . . . , L, and w_{c}=0. The dashed line shows the desired beam pattern in EQ. (37) scaled by the optimal value of α. FIG. 4(c) shows the corresponding optimal phased-array beam pattern (obtained using the additional constraint rank(R)=1). Note that the phased-array beam pattern has higher sidelobe levels than its MIMO counterpart. Also, note that the synthesized MIMO transmit beam pattern is symmetric (or nearly so), which is quite natural in view of the fact that the desired pattern is symmetric, whereas the optimal phased-array beam pattern is asymmetric (generating a symmetric pattern with a phased-array would worsen the matching performance significantly). More importantly, in the presence of multiple targets, even though phased-arrays can be used to form a transmit beam pattern with peaks at the target locations, no data-adaptive approach can be used for localization or detection purposes since the signals reflected by the targets are coherent with each other.

FIGS. 5(a) and 5(b) pertain to MIMO beam pattern matching designs with Δ=5° under the uniform elemental power constraint. FIG. 5(a) is a plot of the cross-correlation coefficients of the three target reflected signals as functions of w_{c}, and FIG. 5(b) provides a comparison of the beam patterns obtained with w_{c}=0 and w_{c}=1. The desired beam pattern (scaled by α) is shown by the dotted line. Note that although w_{c}=0 is used to obtain FIG. 4(b), the signals reflected by the targets exhibit low cross-correlations among them. As Δ is decreased, however, the cross-correlations become stronger when w_{c}=0; consequently to achieve low cross-correlations in such a case, the weight of the second term of the cost function in EQ. (19) can be increased The normalized magnitudes of the cross-correlation coefficients of the target reflected signals, as functions of w_{c}, are shown in FIG. 5(a) for Δ=5°. Note that when w_{c} is close to zero, the first and third reflected signals are highly correlated, which can degrade significantly the performance of any adaptive technique. For w_{c}=1, on the other hand, all cross-correlation coefficients are approximately zero. An example of the beam pattern obtained with w_{c}=1 is shown in FIG. 3(b), where it is compared with the corresponding beam pattern obtained with w_{c}=0 as well as with the desired beam pattern (scaled by α). Note that the designs obtained with w_{c}=1 and with w_{c}=0 are similar to one another even though the cross-correlation behavior of the former is much better than that of the latter.

In practice, the theoretical covariance matrix R of the transmitted signals is realized via the sample covariance matrix

$${\hat{R}}_{xx} = \frac{1}{N} {\sum }_{n = 1}^{N} x ( n ) {x}^{⋆} ( n ) ,$$

which may cause the synthesized transmit beam pattern to be slightly different from the designed beam pattern (unless Rₓₓ=R, which holds for instance if x(n)=R^{1/2}w(n) and

$$\frac{1}{N} {\sum }_{n = 1}^{N} w ( n ) {w}^{*} ( n ) = I$$

exactly; in what follows, however, it is assumed that {w(n)} is a temporally and spatially white signal from which the last equality holds only approximately in finite samples.) Let ε(θ) denote the relative difference of the beam patterns obtained by using \hat{R}ₓₓ and R:

$$ɛ ( θ ) = \frac{{a}^{*} ( θ ) ( {\hat{R}}_{xx} - R ) a ( θ )}{{a}^{*} ( θ ) Ra ( θ )} , θ ∈ [ - 90 ° , 90 ° ] , \qquad ( 38 )$$

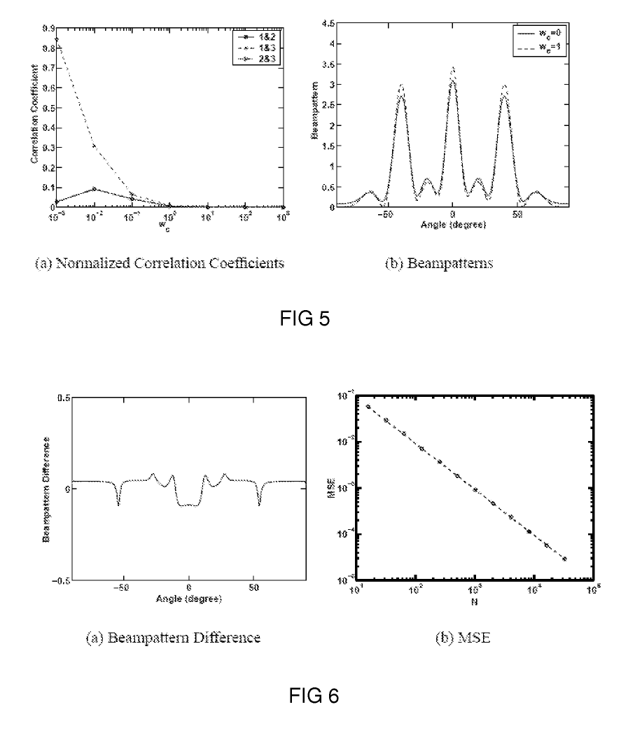

FIGS. 6(a) and 6(b) provide an analysis of the beam pattern difference resulting from using \hat{R}ₓₓ in lieu of R is shown. FIG. 6(a) plots beam pattern difference versus 9 when N=256, and FIG. 6(b) plots the average MSE of the beam pattern difference as a function of the sample number N. FIG. 6(a) provides an example of s(S), as a function of θ, for the beam pattern design in FIG. 5(b) with w_{c}=1 and for N=256. Note that the difference is quite small. The mean-squared error (MSE) between the beam patterns obtained by using \hat{R}ₓₓ and R as the average of the square of EQ. (5) over all mesh grid points and over the set of Monte-Carlo trials is defined. The MSE is a function of N, obtained from 1000 Monte-Carlo trials, as shown in FIG. 6(b). As expected, the larger the sample number N, the smaller the MSE.

Next, estimating the complex amplitudes {βₖ} of the reflected signals is addressed, in addition to estimating their location parameters {θₖ}. The approximate maximum likelihood (AML) approach can be used to estimate the amplitude vector β=[β₁ . . . β_{\hat{K}}]^{T}. Herein, {\hat{θ}ₖ}ₖ₌₁^{\hat{K}} denotes the estimated target locations and

A=[a(\hat{θ}₁) . . . a(\hat{θ}_{\hat{K}})]. (39)

Accordingly,

β_{AML}=[(A^{T}T⁻A^{c})(A^{T}\hat{R}ₓₓ^{c}A^{c})]⁻¹vecd(A^{T}T⁻¹\hat{R}_{yx}A), (40)

where denotes the Hadamard product, vecd(•) denotes a column vector formed by the diagonal elements of a matrix, and

T=\hat{R}_{yy}−\hat{R}_{yx}A(A*\hat{R}ₓₓA)⁻¹A*\hat{R}_{yx*}* (41)

The MSEs of the location estimates obtained by Capon and of the complex amplitude estimates obtained by AML can be examined. In particular, the MSEs obtained using the initial omni directional probing can be compared with those obtained using the optimal beam pattern matching design shown in FIG. 3B with Δ=5° and w_{c}=1.

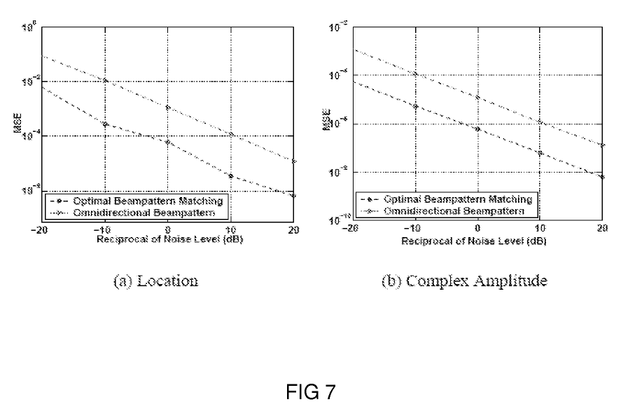

FIG. 7(a) shows MSEs of the location estimates and FIG. 7(b) the complex amplitude estimates for the first target, as functions of −10 log₁₀ σ², obtained with initial omni directional probing and with probing using the beam pattern matching design with Δ=5° and w_{c}=1, under the uniform elemental power constraint. FIGS. 7(a) and 7(b), more particularly, show the MSE curves of the location and complex amplitude estimates obtained for the first target from 1000 Monte-Carlo trials (the results for the other targets are similar). The estimates obtained using the optimal beam pattern matching design are much better: the SNR gain over the omni directional design is larger than 10 dB.

Consider now an example where two of the targets are closely spaced. It is assumed that there are K=3 targets, located at θ₁=−40°, θ₂=0°, and θ₃=3° with complex amplitudes equal to β₁=β₂=β₃=1. There is a strong jammer at 25° with an unknown waveform, which is uncorrelated with the transmitted WD waveforms, and with a power equal to 10⁶ (60 dB). Each transmitted signal pulse has N=256 samples. The received signal is corrupted by zero-mean circularly symmetric spatially and temporally white Gaussian noise with variance σ²=−10 dB.

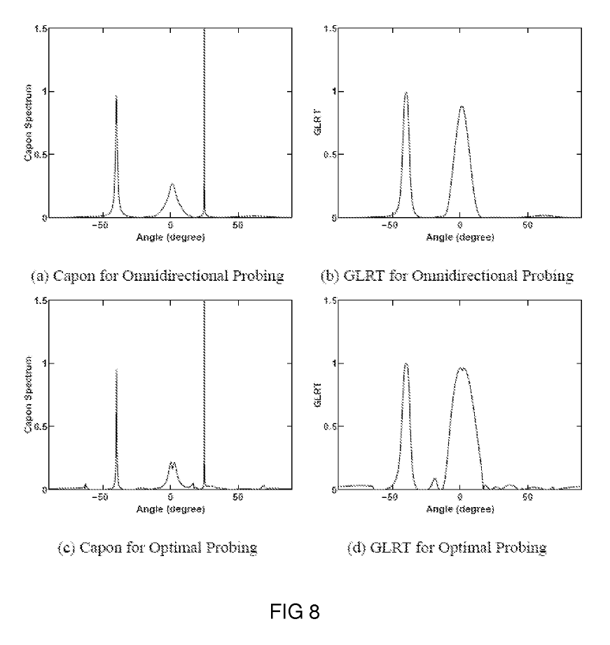

FIGS. 8(a)-(d) pertain to Capon spatial spectra and the GLRT pseudo-spectra as functions of θ. FIG. 8(a) illustrates Capon for the initial omni directional probing. FIG. 8(b) shows GLRT for the initial omni directional probing. FIG. 8(c) shows Capon for the optimal probing. FIG. 8(d) illustrates GLRT for the optimal probing. FIGS. 8(a) and 8(b), more particularly, show the Capon spectrum and the GLRT pseudo-spectrum, respectively, for the initial omni directional probing; as can be seen from these figures, the two closely spaced targets cannot be resolved. Using this initial probing result, an optimal beam pattern matching design can be derived using EQ. (19) with a mesh grid size of 0.1°, wₗ=1, l=1, . . . , L, and w_{c}=1. Since the initial probing indicated only two dominant peaks, these two peak locations are used in EQ. (37). The desired beam pattern is given by EQ. (4) with Δ=10° and \hat{K}=2. FIGS. 6C and 6D, respectively, show the Capon spectrum and the GLRT pseudo-spectrum for the optimal probing. In principle, the two closely spaced targets are now resolved.

Lastly, consider an example where the desired beam pattern has only one wide beam centered at 0° with a width of 60°. FIGS. 9(a) and 9(b) pertain to results for the beam pattern matching design in EQ. (19) with a mesh grid size of 0.1°, wₗ=1, l=1, . . . , L, and w_{c}=0. FIG. 9(a) shows beam pattern matching designs under the uniform elemental power constraint for the MIMO. FIG. 9(b) shows beam pattern matching designs under the uniform elemental power constraint for the phased-array. FIG. 9(b), more particularly, shows the corresponding phased-array beam pattern obtained by using the additional constraint of rank(R)=1 in EQ. (19). Note that, under the elemental power constraint, the number of degrees of freedom (DOF) of the phased-array that can be used for beam pattern design is equal to only M−1 (real-valued parameters); consequently, it is difficult for the phased-array to synthesize a proper wide beam. The MIMO design, however, can be used to achieve a beam pattern significantly closer to the desired beam pattern due to its much larger number of DOF, viz. M²−M. Interestingly, under the total power constraint, the optimal MIMO beam pattern and the optimal phased-array beam pattern are observed to be quite close to one another. The elemental powers of the phased-array design obtained under the total power constraint, however, varied significantly, which may be undesirable in many applications.

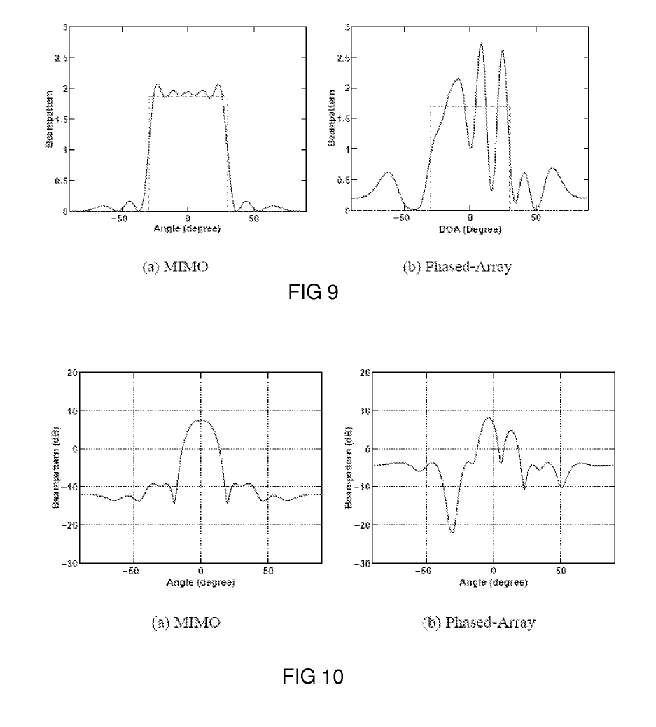

Consider the beam pattern design problem in EQ. (32) with the main-beam centered at θ₀=0° and with a 3 dB width equal to 20° (θ₁=−10°, θ₂=10°). The sidelobe region is Ω=[−90°, −20°]∪[20°,90°]. The minimum-sidelobe beam pattern design obtained by using EQ. (32) with a mesh grid size of 0.1° is shown in FIG. 10A. Note that the peak sidelobe level achieved by the MIMO design is approximately 18 dB below the main lobe peak level. FIG. 10(a) shows Minimum sidelobe beam pattern designs, under the uniform elemental power constraint, when the 3 dB main-beam width is 20° for the MIMO beam pattern. FIG. 10(b) shows the corresponding phased-array beam pattern obtained by using the additional constraint rank(R)=1 in EQ. (32). The phased-array design fails to provide a proper main lobe (it suffers from peak splitting) and its peak sidelobe level is about 5 dB higher than that of its MIMO counterpart.

FIGS. 9(a) and 9(b) are similar to FIGS. 10(a) and 10(b) except that elemental powers have been allowed to be between 80% and 120% of c/M= 1/10, while the total power is still constrained to be c=1. By allowing such a flexibility in setting the elemental powers, the peak sidelobe level of the MIMO beam pattern can be brought down by more than 3 dB. The phased-array design, on the other hand, does not appear to improve in any significant way.

Several transmit beam pattern design problems for WD systems have been evaluated herein. The invention enables the resulting beam pattern designs by focusing the transmit power around locations of targets of interest while minimizing the cross-correlations of the signals reflected back to the radar. The parameter estimation accuracy of these adaptive WD techniques can be significantly improved as well as the resolution. Due to the significantly larger number of degrees of freedom of a MIMO system, better transmit beam patterns can be achieved under the practical uniform elemental transmit power constraint with a WD system, as described herein.

Where applicable, the present embodiments of the invention can be realized in hardware, software or a combination of hardware and software. Any kind of computer system or other apparatus adapted for carrying out the methods described herein are suitable. A typical combination of hardware and software can be a mobile communications device with a computer program that, when being loaded and executed, can control the mobile communications device such that it carries out the methods described herein. Portions of the present method and system may also be embedded in a computer program product, which comprises all the features enabling the implementation of the methods described herein and which when loaded in a computer system, is able to carry out these methods.

The terms “program,” “software application,” and the like as used herein, are defined as a sequence of instructions designed for execution on a computer system. A program, computer program, or software application may include a subroutine, a function, a procedure, an object method, an object implementation, an executable application, a source code, an object code, a shared library/dynamic load library and/or other sequence of instructions designed for execution on a computer system.

While the preferred embodiments of the invention have been illustrated and described, it will be clear that the embodiments of the invention is not so limited. Numerous modifications, changes, variations, substitutions and equivalents will occur to those skilled in the art without departing from the spirit and scope of the present embodiments of the invention as defined by the appended claims.

What is claimed is:

1. A method of designing a transmit beampattern based upon waveform diversity, the method comprising:
determining a covariance matrix of sample vectors representing a plurality of transmitted signal pulses, wherein the covariance matrix is such that a transmit beampattern based upon the covariance matrix approximates a predetermined desired transmit beampattern; and
transmitting the transmit beampattern based upon the determined covariance matrix.

2. The method of claim 1, wherein the step of determining the covariance matrix comprises determining the covariance matrix that causes the transmit beampattern to approximate the desired beampattern by satisfying a least squares criterion.

3. The method of claim 1, wherein the step of determining the covariance matrix comprises determining the covariance matrix that causes the transmit beampattern to approximate the desired transmit beampattern over a set comprising predetermined sectors of interest.

4. The method of claim 3, wherein the step of determining the covariance matrix comprises determining the covariance matrix that minimizes a cross-correlation beampattern at prescribed locations.

5. A method of designing a transmit beampattern based upon waveform diversity, the method comprising:
determining a covariance matrix of sample vectors representing a plurality of transmitted signal pulses, wherein the covariance matrix is such that a transmit beampattern based upon the covariance matrix maximizes spatial power of the probing signal at a target location; and
transmitting the transmit beampattern based upon the determined covariance matrix.

6. The method of claim 5, wherein the step of determining comprises determining the covariance matrix such that a cross-correlation at different target locations is minimized.

7. The method of claim 5, wherein the step of determining comprises determining the covariance matrix to satisfy a uniform elemental power constraint.

8. A method of designing a transmit beampattern based upon waveform diversity, the method comprising:
determining a covariance matrix of sample vectors representing a plurality of transmitted signal pulses forming a transmit beampattern, wherein the covariance matrix is such that a sidelobe of the transmit beampattern is minimized at predetermined region; and
transmitting the transmit beampattern based upon the determined covariance matrix.

9. The method of claim 8, wherein the step of determining comprises determining the covariance matrix such that the transmit beampattern has a predetermined main-beam width.

10. A method of designing a transmit beampattern based upon waveform diversity, the method comprising:
transmitting a transmit beam pattern comprising a plurality of probing signals;
increasing a total probing signal power of the plurality of probing signals at one or more target locations; and
reducing the cross-correlations at the one or more target locations.

11. The method of claim 10, further comprising designing a covariance matrix for the one or more probing signals to minimize a beampattern matching error to a desired beampattern and minimize the total probing signal power at locations other than the target locations.

12. The method of claim 11, wherein the minimizing includes minimizing a sidelobe pattern at prescribed target locations by subjecting an elemental power constraint, wherein an elemental power constraint applies uniform power to a transmitting array of probing signals.

13. The method of claim 10, further comprising:
calculating an array steering vector;
calculating a covariance matrix of the plurality of probing signals; and
determining the total probing signal power at the target location by multiplying together a conjugate transpose of the array steering vector and the covariance matrix and the steering vector.

14. The method of claim 13, further comprising
estimating the one or more target locations;
estimating a desirable transmit beam-pattern;
adjusting the covariance matrix of the plurality of probing signals to match the transmit beam pattern to the desirable transmit beam-pattern at the one or more target locations and minimize a cross-correlation beam pattern at the one or more target locations, wherein the adjusting is based on a beam pattern matching criterion that minimizes a least squares error fitting; and
transmitting the transmit beam pattern.

15. The method of claim 14, further comprising imposing a uniform elemental power constraint, or total transmit power constraint, at all transmitters generating the transmit beam pattern.

16. The method of claim 14, wherein the beam pattern matching criterion includes a user term that penalizes large values of the cross-correlation beam pattern.

17. The method of claim 14, wherein the least squares error fitting is directly applied to the desirable transmit beam-pattern.

18. The method of claim 14, further comprising determining an optimal scaling factor to approximate a scaled version of the beam pattern.

19. The method of claim 14, further comprising employing a Semidefinite Quadratic Programming (SQP) algorithm for designing the covariance matrix in polynomial time to match the transmit beam-pattern with the desirable transmit beam-pattern.

20. The method of claim 14, wherein the estimating a desirable transmit beam-pattern includes:
transmitting omnidirectional power towards all targets;
receiving one or more reflection signals;
computing a generalized likelihood ratio test function on the reflection signals; and
identifying peaks within the output of the generalized likelihood ratio test function, wherein the peaks correspond to the one or more target locations.

21. The method of claim 20, further comprising:
applying Capon beam forming to the reflection signals for producing an output; and
identifying peaks that correspond the one or more target locations.

22. The method of claim 21, wherein the identifying peaks further includes selecting peaks having widths based on an accuracy of estimated target locations.

23. A method of flexible waveform design using waveform diversity, comprising:
pointing an array beam in a prescribed direction for emiting a plurality of probing signals;
calculating a covariance matrix of the plurality of probing signals; and
minimizing sidelobe levels, wherein an elemental power constraint applies uniform power to a transmitting array of probing signals.

24. The method of claim 23, further comprising replacing the elemental power constraint with a total power constraint;

25. The method of claim 23, further comprising introducing flexibility to the elemental power constraint by allowing the elemental power to be within a predetermined range around the uniform power.

26. A method of designing a probing signal comprising:
estimating a desirable transmit beam-pattern;
approximating probing signal to match a given transmit beam pattern;
transmitting the probing signal and receiving a reflection signal; and
updating the probing signal to match the given transmit beam pattern by adjusting a covariance matrix to increase a total probing signal power of the plurality of probing signals at one or more target locations and reduce the cross-correlations between the plurality of probing signals at the one or more target locations.

27. The method of claim 26, wherein the designing includes imposing an elemental power constraint on all transmit antennaes.

28. The method of claim 26, further comprising employing an efficient Semidefinite Quadratic Programming (SQP) algorithm for updating the covariance matrix in polynomial time to match the transmit beam-pattern with the desirable transmit beam-pattern.

29. The method of claim 26, further comprising including a first weight factor for beampattern matching and a second weight factor for a cross-correlation among the reflection signal.

30. A system for designing a transmit beam pattern for Waveform Diversity (WD), comprising:
a transmitter having a plurality of transmit antenna for transmitting a transmit beam pattern comprising a plurality of probing signals; and
a processor for increasing a total probing signal power of the plurality of probing signals at one or more target locations, and reducing the cross-correlations between the plurality of probing signals at the one or more target locations.

31. The system of claim 30, further comprising a receiver for receiving one or more signals reflected back from the one or more targets.

32. A system for flexible waveform design using waveform diversity, comprising:
multiple transmitting antennae for pointing an array beam in a prescribed direction for emitting a plurality of probing signals; and
a processor for calculating a covariance matrix of the plurality of probing signals and minimizing sidelobe levels by imposing an elemental power constraint at the prescribed direction, wherein an elemental power constraint applies uniform power to a transmitting antenna of a probing signal.

33. A system for beampattern matching design, comprising:
multiple transmitting antennae for pointing an array beam in a prescribed direction for emitting a plurality of probing signals having a transmit beampattern; and
a processor for calculating a covariance matrix of the plurality of probing signals and minimizing a cross-correlation for matching a desired beampattern with the transmit beampattern in the prescribed direction.

34. The system of claim 33, wherein the processor performs a least squares fitting for the prescribed direction.

35. The system of claim 33, wherein the processor includes a scaling factor prior to the least squares fitting for approximating an appropriately scaled version of the beampattern in the prescribed direction.

36. The system of claim 33, wherein the processor penalizes large values of the cross-correlation.

37. The system of claim 32, wherein the processor employs an efficient Semi-definite Quadratic Programming (SQP) algorithm to solve the signal design problem in polynomial time.
